(19) United States
(12) Patent Application Publication
(10) Pub. No.: US 2024/0296668 A1
(43) Pub. Date: Sep. 5, 2024

(54) SAMPLE-ADAPTIVE CROSS-LAYER NORM CALIBRATION AND RELAY NEURAL NETWORK

(71) Applicant: Intel Corporation, Santa Clara, CA (US)

(72) Inventors: Dongqi Cai, Beijing (CN); Yurong Chen, Beijing (CN); Anbang Yao, Beijing (CN)

(21) Appl. No.: 18/572,510

(22) PCT Filed: Sep. 10, 2021
(86) PCT No.: PCT/CN2021/117666

§ 371 Date: Dec. 20, 2023

(51) Int. Cl. G06V 10/82; G06V 10/94

(52) U.S. Cl. CPC G06V 10/82; G06V 10/955

(57) ABSTRACT

Technology to conduct image sequence/video analysis can include a processor, and a memory coupled to the processor, the memory storing a neural network, the neural network comprising a plurality of convolution layers, and a plurality of normalization layers arranged as a relay structure, wherein each normalization layer is coupled to and following a respective one of the plurality of convolution layers. The plurality of normalization layers can be arranged as a relay structure where a normalization layer for a layer (k) is coupled to and following a normalization layer for a preceding layer (k−1). The normalization layer for the layer (k) is coupled to the normalization layer for the preceding layer (k−1) via a hidden state signal and a cell state signal, each signal generated by the normalization layer for the preceding layer (k−1). Each normalization layer (k) can include a meta-gating unit (MGU) structure.

### TECHNICAL FIELD

Embodiments generally relate to computing systems. More particularly, embodiments relate to performance-enhanced deep learning technology for image sequence analysis.

### BACKGROUND

Analysis of image sequences, such as obtained from video, is a fundamental problem and challenging task in many important usage scenarios. Deep learning networks such as, for example, convolution neural networks (CNNs), have become an important candidate technology to be considered for use in analysis of image sequences/video. Analysis of image sequences/video, however, presents additional and specific challenges compared to tasks focused on single images. For example, on the one hand, short-range and long-range temporal information in image sequences/video exhibits much more complicated feature distribution variations and requires higher performance modeling capabilities for video models. On the other hand, the huge memory and compute demand of video models restricts the training batch size to a much smaller range compared to settings for single-image tasks. These characteristics make the training of video models difficult to converge and extremely time-consuming, preventing use of deep CNNs for high performance image sequence/video analysis.

### BRIEF DESCRIPTION OF THE DRAWINGS

The various advantages of the embodiments will become apparent to one skilled in the art by reading the following specification and appended claims, and by referencing the following drawings, in which:

FIG. 1 is a diagram illustrating an overview of an example of a system for image sequence analysis according to one or more embodiments;

FIGS. 2A-2B provide block diagrams of examples of a neural network structure according to one or more embodiments;

FIG. 3 is a diagram illustrating an example of a normalization layer for a neural network according to one or more embodiments;

FIGS. 4A-4B are diagrams illustrating examples of a meta-gating unit (MGU) structure for a normalization layer of a neural network according to one or more embodiments;

FIGS. 5A-5B are flowcharts illustrating an example of a method of constructing a neural network according to one or more embodiments;

FIGS. 6A-6F are illustrations of example input image sequences and corresponding activation maps in a system for image sequence analysis according to one or more embodiments;

FIG. 7 is a block diagram illustrating an example of a computing system for image sequence analysis according to one or more embodiments;

FIG. 8 is a block diagram illustrating an example of a semiconductor apparatus according to one or more embodiments;

FIG. 9 is a block diagram illustrating an example of a processor according to one or more embodiments; and

FIG. 10 is a block diagram illustrating an example of a multiprocessor-based computing system according to one or more embodiments.

### DESCRIPTION OF EMBODIMENTS

A performance-enhanced computing system as described herein improves performance of CNNs for image sequence/video analysis. The technology helps improve the overall performance of deep learning computing systems from the perspective of feature representation calibration and association through feature norm calibration and association techniques called Sample-Adaptive Cross-Layer Norm Calibration and Relay (CLN-CR). The CLN-CR technology described herein can be applied to any deep CNN to provide a significant performance boost to image sequence/video analysis tasks in at least two ways. First, to introduce adaptiveness and increase the robustness for holistic video feature distribution modeling, the CLN-CR technology learns calibration and association parameters conditioned on each specific video sample in a dynamic way by calibrating feature tensors conditioned on a given video sample. Second, the CLN-CR technology described herein uses a relay mechanism to associate the relations of calibration parameters across neighboring layers along network depth (rather than merely learning calibration and association parameters independently for each layer). By employing these dynamic learning and cross-layer relay capabilities, the technology resolves possible inaccurate mini-batch statistics estimation for feature norm calibration and improves performance in accuracy as to identifying regions of interest/importance, under restricted mini-batch size settings. Additionally, the technology provides for a significant improvement in training speed.

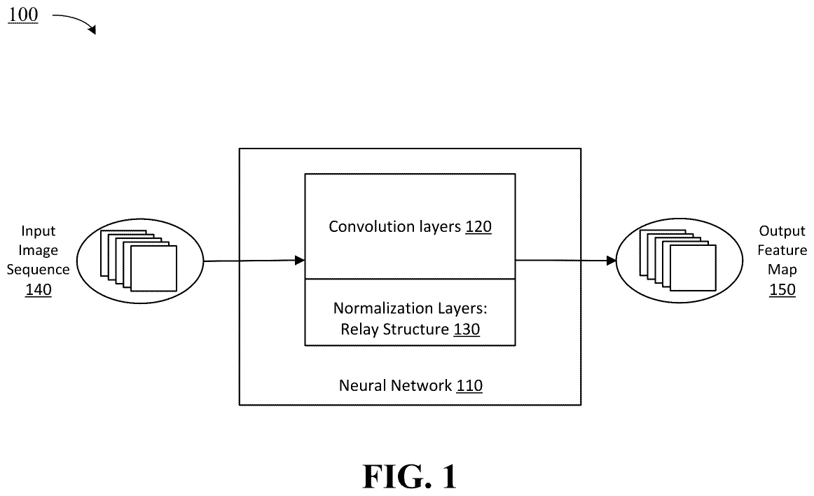

FIG. 1 provides a diagram illustrating an overview of an example of a system 100 for image sequence analysis according to one or more embodiments, with reference to components and features described herein including but not limited to the figures and associated description. The system 100 includes a neural network 110 which, arranged as described herein, incorporates a sample-aware mechanism that dynamically generates calibration parameters conditioned on each input video sample to overcome possible inaccurate mini-batch statistics estimation under restricted mini-batch size settings. The neural network 110 can be a CNN that includes a plurality of convolution layers 120. In some embodiments, the neural network 110 can include other types of neural network structures. The neural network 110 further includes a plurality of normalization layers arranged as a relay structure 130 to associate holistic dependencies of dynamically generated calibration parameters across neighboring layers. Each of the normalization layers in the relay structure 130 is coupled to and following a respective convolution layer of the plurality of convolution layers 120.

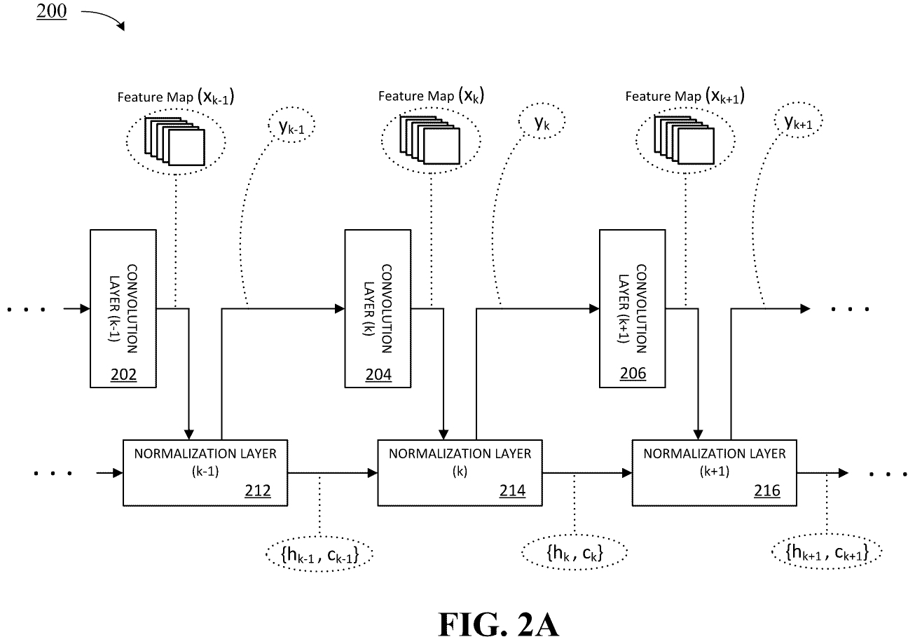

The neural network 110 receives as input an image sequence 140. The image sequence 140 can include, e.g., a video comprised of a sequence of images associated with a period of time. The neural network 110 produces an output feature map 150. The output feature map 150 represents the results of processing the input image sequence 140 via the neural network 110, results which can include classification, detection and/or segmentation of objects, features, etc. from the input image sequence 140. Further details regarding the neural network 110 are provided herein with reference to FIGS. 2A-2B, 3, 4A-4B and 5A-5B.

FIG. 2A provides a block diagram of an example of a neural network structure 200 according to one or more embodiments, with reference to components and features described herein including but not limited to the figures and associated description. The neural network structure 200 can be utilized in all or a portion of the neural network 110 (FIG. 1, already discussed). The neural network structure 200 includes a plurality of convolution layers, including a convolution layer 202 (representing a layer k−1), a convolution layer 204 (representing a layer k), and a convolution layer 206 (representing a layer k+1). The convolution layer 202 operates to provide an output feature map xₖ₋₁. Similarly, the convolution layer 204 operates to provide an output feature map xₖ, and the convolution layer 206 operates to provide an output feature map xₖ₊₁. The convolution layers (such as the convolution layer 202, the convolution layer 204, and the convolution layer 206) correspond to the convolution layers 120 (FIG. 1, already discussed), and have parameters and weights that are determined through a neural network training process.

The neural network structure 200 further includes a plurality of normalization layers arranged in a relay structure, including a normalization layer 212 (for layer k−1), a normalization layer 214 (for layer k), and a normalization layer 216 (for layer k+1). Each normalization layer is coupled to and following a respective convolution layer of the plurality of convolution layers, such that each normalization layer receives an input from the respective convolution layer and provides an output to a succeeding layer. Each normalization layer (that is, each normalization layer after the initial normalization layer in the neural network) is also coupled to and following a respective preceding normalization layer via a hidden state signal and a cell state signal, by receiving a hidden state signal and a cell state signal from the respective preceding normalization layer. Thus, as shown in the example of FIG. 2A, the relay structure includes arranging, for each layer (k), a normalization layer for the layer (k) as coupled to and following a normalization layer for a preceding layer (k−1). The normalization layers as so arranged correspond to the relay structure 130 (FIG. 1, already discussed). For example, the normalization layer 212 (for layer k−1) receives as input the feature map xₖ₋₁ from the convolution layer 202. The normalization layer 212 also receives a hidden state signal and a cell state signal from a preceding normalization layer (not shown in FIG. 2A), unless the normalization layer 212 is the initial normalization layer in the neural network (in which case there would be no preceding normalization layer). The normalization layer 212 operates to provide an output feature map yₖ₋₁. As illustrated for the example of FIG. 2A, the output yₖ₋₁ feeds into the convolution layer 204.

Similarly, the normalization layer 214 (for layer k) receives as input the feature map xₖ from the convolution layer 204, and also receives a hidden state signal hₖ₋₁ and a cell state signal cₖ₋₁ from the preceding normalization layer 212. Thus, as shown in the example of FIG. 2A, the normalization layer for the layer (k) is coupled to the normalization layer for the preceding layer (k−1) via a hidden state signal and a cell state signal, each of the hidden state signal and a cell state signal generated by the normalization layer for the preceding layer (k−1). The normalization layer 214 operates to provide an output feature map yₖ. As illustrated for the example of FIG. 2A, the output yₖ feeds into the convolution layer 206. For the next layer, the normalization layer 216 (for layer k+1) receives as input the feature map xₖ₊₁ from the convolution layer 206, and also receives a hidden state signal hₖ and a cell state signal cₖ from the preceding normalization layer 214. The normalization layer 216 operates to provide an output feature map yₖ₊₁, which can feed into a succeeding layer (not shown in FIG. 2A). The neural network structure 200 illustrated in FIG. 2A may continue repetitively for all or part of the remainder of the neural network.

FIG. 2B provides a block diagram of another example of a neural network structure 250 according to one or more embodiments, with reference to components and features described herein including but not limited to the figures and associated description. The neural network structure 250 includes many of the same features that are shown in and described with reference to the neural network structure 200 (FIG. 2A) and will not be repeated herein. In addition to the features described with reference to the neural network structure 200 (FIG. 2A), the neural network structure 250 can include one or more optional activation layers, such as activation layer(s) 252, 254, and 256, and/or one or more additional/optional layers, such as convolution layer(s) 253 and 255; other optional neural network layers are possible. Each of the activation layer(s) 252, 254, and/or 256 can include an activation function useful for CNNs, such as, e.g., a rectified linear unit (ReLU) function, a SoftMax function, etc.

The activation layer(s) 252, 254, and/or 256, can receive, as input, the output of the respective neighboring normalization layer 212, 214 and/or 216. For example, as illustrated in FIG. 2B the activation layer 252 receives, as input, the output yₖ₋₁ from the normalization layer 212, and the output of the activation layer 252 feeds into a convolution layer such as optional convolution layer 253 (if present) or convolution layer 204. Similarly, as illustrated in FIG. 2B the activation layer 254 receives, as input, the output yₖ from the normalization layer 214, and the output of the activation layer 254 feeds into a convolution layer such as optional convolution layer 255 (if present) or convolution layer 206. Likewise, as illustrated in FIG. 2B the activation layer 256 receives, as input, the output yₖ₊₁ from the normalization layer 216, and the output of the activation layer 256 feeds into a next layer (if present). In some embodiments, the activation functions of activation layer(s) 252, 254 and/or 256 can be incorporated into the respective neighboring normalization layer 212, 214 and/or 216. In some embodiments, each of the activation layer(s) 252, 254 and/or 256 can be arranged between the respective convolution layer and the following normalization layer.

Each optional convolution layer 253 and/or 255 receives input from the activation layer(s) 252 and/or 254, respectively (if present); if the activation layer(s) 252 and/or 254 are not present, the optional convolution layer 253 and/or 255 can receive, as input, the output of the respective preceding normalization layer 212 and/or 214. The output of the optional convolution layers 253 and/or 255 can feed into the convolution layers 204 and/or 206, respectively, or into other optional neural network layers (if present).

Some or all components and features of the neural network structure 200 and/or the neural network structure 250 can be implemented using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, components and features of the neural network structure 200 and/or the neural network structure 250 can be implemented in one or more modules as a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), FPGAs, complex programmable logic devices (CPLDs), in fixed-functionality logic hardware using circuit technology such as, for example, ASIC, complementary metal oxide semiconductor (CMOS) or transistor-transistor logic (TTL) technology, or any combination thereof.

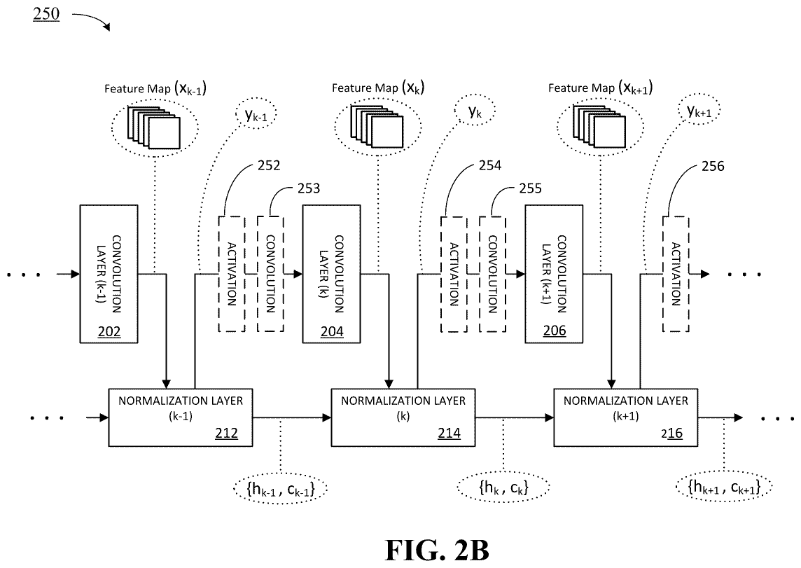

FIG. 3 provides a diagram illustrating an example of a normalization layer 300 for a neural network according to one or more embodiments, with reference to components and features described herein including but not limited to the figures and associated description. The normalization layer 300 can correspond to any of the normalization layers 212, 214 and/or 216 (FIGS. 2A-2B, already discussed). As illustrated in FIG. 3, the normalization layer 300 will be described with reference to layer k (e.g., corresponding to normalization layer 214 of FIGS. 2A-2B). The normalization layer 300 receives, as an input, the output feature map xₖ of the convolution layer for layer k (e.g., the convolution layer 204 illustrated in FIGS. 2A-2B, already discussed). The feature map xₖ can represent, for example, a video (or image sequence) feature map, which is a feature tensor having a temporal dimension T along with other dimensions associated with an image:

$$x ∈ {ℝ}^{N \times C \times T \times H \times W} \qquad EQ . ( 1 )$$

where N,C,T,H,W indicate batch size, number of channels, temporal length, height and width, respectively, for the tensor x.

The normalization layer 300 can include a global average pooling (GAP) function 302, a meta gating unit structure (MGU) 304, a standardization (STD) function 306, and a linear transformation (LNT) function 308. The GAP function 302 is a function known for use in CNNs. The GAP function 302 operates on the feature map xₖ (e.g., the feature map xₖ generated by the convolution layer 204 for layer k in FIGS. 2A-2B) by computing the average output of the feature map xₖ to generate an output x̅ₖ:

$${\overline{x}}_{k} = GAP ( {x}_{k} ) \qquad EQ . ( 2 )$$

which represents a spatial-temporal aggregation of the input feature map xₖ. For an input feature map having dimensionality (N×C×T×H×W), the GAP function 302 produces a resulting output of dimensionality (N×C×1).

The output of the GAP function 302, x̅ₖ, feeds into the MGU 304. The MGU 304 is a shared lightweight structure enabling dynamic generation of feature calibration parameters and relaying these parameters between neighboring layers along the neural network depth. The MGU 304 of the normalization layer (k) receives additional input from the preceding normalization layer (k−1) in the form of a hidden state signal hₖ₋₁ and a cell state signal cₖ₋₁, and generates an updated hidden state signal hₖ and an updated cell state signal cₖ:

$$( {h}_{k} , {c}_{k} ) = MGU ( {\overline{x}}_{k} , ( {h}_{k - 1} , {c}_{k - 1} ) ) \qquad EQ . ( 3 )$$

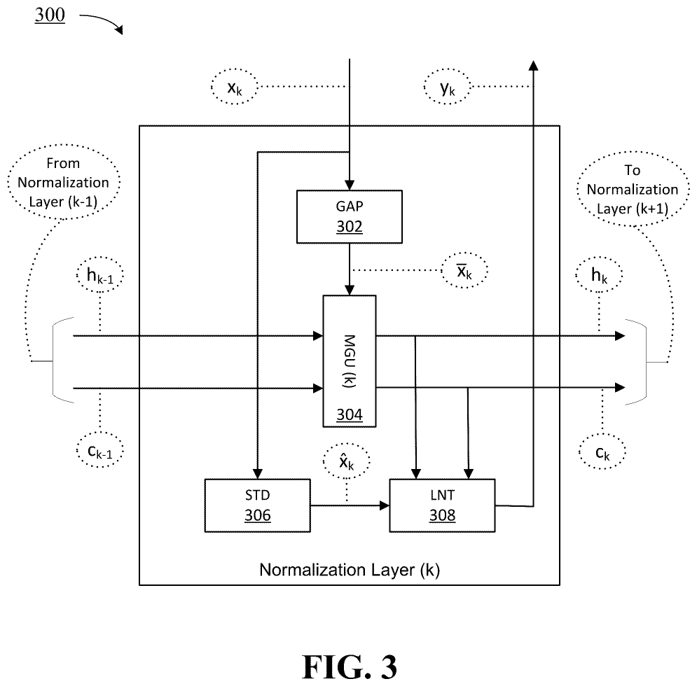

The updated hidden state signal hₖ and the updated cell state signal cₖ feed into the LNT function 308, and also feed into the succeeding normalization layer (k+1). Further details regarding the MGU 304 are provided herein with reference to FIGS. 4A-4B.

The STD function 306 operates on the input feature map xₖ by computing a standardized feature as follows:

$${\hat{x}}_{k} = \frac{{x}_{k} - μ}{\sqrt{{σ}^{2} + ϵ}} \qquad EQ . ( 4 )$$

where μ and σ are mean and standard deviation computed within non-overlapping subsets of the input feature map, and ϵ is a small constant to preserve numerical stability. The output of the STD function 306, \hat{x}ₖ, is a standardized feature expected to be in a distribution with zero mean and unit variance. The standardized feature, \hat{x}ₖ, feeds into the LNT function 308.

The LNT function 308 operates on the standardized feature, \hat{x}ₖ, to calibrate and associate the feature representation capacity of the feature map. The LNT function 308 uses the hidden state signal hₖ and the cell state signal cₖ (which, as described herein, are generated by the MGU 304) as scale and shift parameters to compute an output yₖ as follows:

$${y}_{k} = {h}_{k} {\hat{x}}_{k} + {c}_{k} \qquad EQ . ( 5 )$$

where yₖ is the output of the normalization level (k), hₖ and cₖ are the hidden state signal and cell state signal, respectively, generated by the MGU 304 for level k, and \hat{x}ₖ is the standardized feature generated by the STD function 304. In this way, the calibrated video feature yₖ receives the feature distribution dynamics of the previous layer and relays its calibration statistics to the next layer via the shared MGU structure, associating the holistic video feature distribution dependencies between neighboring layers through a relay mechanism.

Some or all components and features of the normalization layer 300 can be implemented using one or more of a CPU, a GPU, an AI accelerator, an FPGA accelerator, an ASIC, and/or via a processor with software, or in a combination of a processor with software and an FPGA or ASIC. More particularly, components and features of the normalization layer 300 can be implemented in one or more modules as a set of logic instructions stored in a non-transitory machine- or computer-readable storage medium such as RAM, read only memory ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

FIG. 4A provides a diagram illustrating an example of an MGU structure 400 for a normalization layer (k) of a neural network according to one or more embodiments, with reference to components and features described herein including but not limited to the figures and associated description. The MGU structure 400 can correspond to the MGU 304 (FIG. 3, already discussed). The MGU structure 400 includes a modified long-short term memory (LSTM) cell 410. The modified LSTM cell 410 can be generated from a LSTM cell used in neural networks; an example of a modified LSTM cell is provided herein with reference to FIG. 4B. The modified LSTM cell 410 receives as input the spatial-temporal aggregation x̅ₖ (EQ. 2) as well as the hidden state signal hₖ₋₁ and the cell state signal cₖ₋₁ from the preceding normalization layer (k−1) to generate an updated hidden state signal hₖ and an updated cell state signal cₖ.

FIG. 4B provides a diagram illustrating an example of an MGU structure 450 for a normalization layer of a neural network according to one or more embodiments, with reference to components and features described herein including but not limited to the figures and associated description. The MGU structure 450 can correspond to the MGU 304 (FIG. 3, already discussed) and/or to the MGU structure 400 (FIG. 4A, already discussed). In particular, the MGU structure 450 comprises an example of a modified LSTM cell, such as the modified LSTM cell 410 (FIG. 4A, already discussed). The MGU structure 450 provides a gating mechanism that can be denoted by:

$$( {f}_{k} , {i}_{k} , {g}_{k} , {o}_{k} ) = ϕ ( [ {\overline{x}}_{k} , {h}_{k - 1} ] ) + b \qquad EQ . ( 6 )$$

where ϕ(⋅) is a bottleneck unit for processing the spatial-temporal aggregation x̅ₖ (EQ. 2) and the hidden state signal hₖ₋₁ from the preceding normalization level (k−1), and b is a bias. For example, the bottleneck unit ϕ(⋅) can be a contraction-expansion bottleneck unit having a fully connected (FC) layer which maps the input to a low dimensional space with the reduction ratio r, a ReLU activation layer, and another FC layer which maps the input back to the original dimensional space. In some embodiments, the bottleneck unit ϕ(⋅) can be implemented as any form of linear or nonlinear mapping. The dynamically-generated parameters fₖ, iₖ, gₖ, oₖ form a set of gates to regularize the update of the cell state signal cₖ and the hidden state signal hₖ of the MGU structure 450 for level (k) as follows:

$${c}_{k} = σ ( {f}_{k} ) ⊙ {c}_{k - 1} + σ ( {i}_{k} ) ⊙ tanh ( {g}_{k} ) \qquad EQ . ( 7 )$$

$$and$$

$${h}_{k} = σ ( {o}_{k} ) ⊙ σ ( {c}_{k} ) \qquad EQ . ( 8 )$$

where cₖ is the updated cell state signal, hₖ is the updated hidden state signal, cₖ₋₁ is the cell state signal from the preceding normalization level (k−1), σ(⋅) is the sigmoid function, and ⊙ is the Hadamard product operator.

Some or all components and features of the MGU structure 400 and/or the MGU structure 450 can be implemented using one or more of a CPU, a GPU, an AI accelerator, an FPGA accelerator, an ASIC, and/or via a processor with software, or in a combination of a processor with software and an FPGA or ASIC. More particularly, components and features of the MGU structure 400 and/or the MGU structure 450 can be implemented in one or more modules as a set of logic instructions stored in a non-transitory machine- or computer-readable storage medium such as RAM, read only memory ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

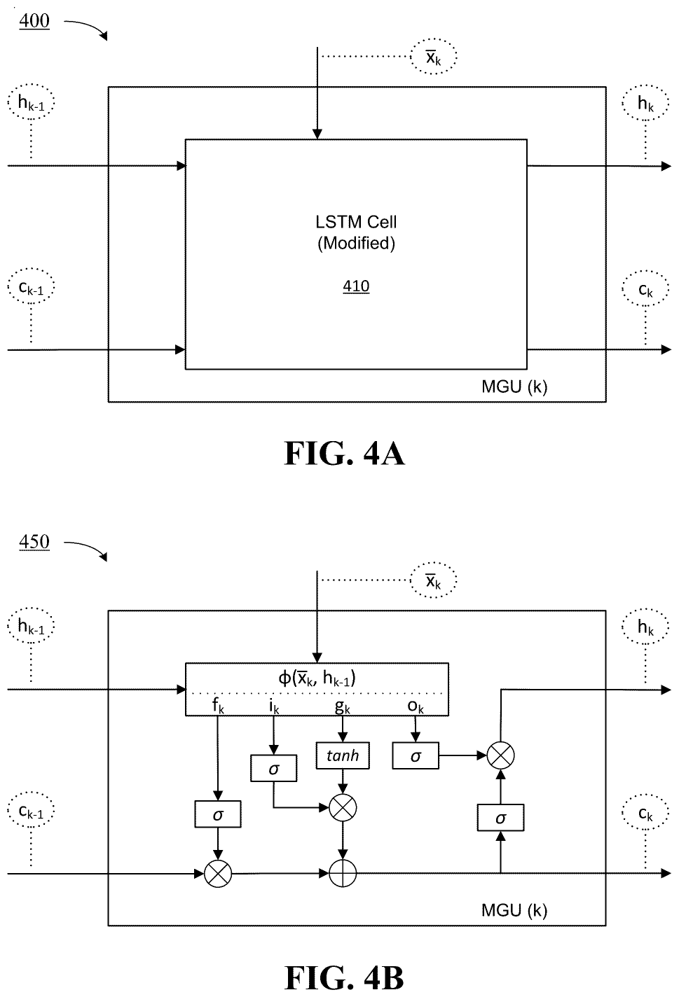

FIG. 5A is a flowchart illustrating a method 500 of constructing a neural network according to one or more embodiments, with reference to components and features described herein including but not limited to the figures and associated description. The method 500 can be employed, e.g., in constructing the neural network 110 (FIG. 1, already discussed), the neural network structure 200 (FIG. 2A, already discussed), and/or the neural network structure 250 (FIG. 2B, already discussed), and can utilize the normalization layer 300 (FIG. 3, already discussed), the MGU structure 400 (FIG. 4A, already discussed), and/or the MGU structure 450 (FIG. 4B, already discussed). The method 500 can generally be implemented in the system 100 (FIG. 1, already discussed), and/or using one or more of a CPU, a GPU, an AI accelerator, an FPGA accelerator, an ASIC, and/or via a processor with software, or in a combination of a processor with software and an FPGA or ASIC. More particularly, the method 500 can be implemented in one or more modules as a set of logic instructions stored in a non-transitory machine- or computer-readable storage medium such as RAM, read only memory ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 502 provides for generating a neural network including a plurality of convolution layers. Illustrated processing block 504 provides for arranging a plurality of normalization layers as a relay structure in the neural network. At illustrated processing block 506, each normalization layer (k) is coupled to and following a respective one of the plurality of convolution layers.

FIG. 5B is a flowchart illustrating a method 520 of constructing a neural network according to one or more embodiments, with reference to components and features described herein including but not limited to the figures and associated description. The method 520 can be employed, e.g., in constructing the neural network 110 (FIG. 1, already discussed), the neural network structure 200 (FIG. 2A, already discussed), and/or the neural network structure 250 (FIG. 2B, already discussed), and can utilize the normalization layer 300 (FIG. 3, already discussed), the MGU structure 400 (FIG. 4A, already discussed), and/or the MGU structure 450 (FIG. 4B, already discussed). The method 520 can generally be implemented in the system 100 (FIG. 1, already discussed), and/or using one or more of a CPU, a GPU, an AI accelerator, an FPGA accelerator, an ASIC, and/or via a processor with software, or in a combination of a processor with software and an FPGA or ASIC. More particularly, the method 520 can be implemented in one or more modules as a set of logic instructions stored in a non-transitory machine- or computer-readable storage medium such as RAM, read only memory ROM, PROM, firmware, flash memory, etc., in configurable logic such as, for example, PLAS, FPGAs, CPLDs, in fixed-functionality logic hardware using circuit technology such as, for example, ASIC, CMOS or TTL technology, or any combination thereof.

At illustrated processing block 522, arranging the plurality of normalization layers as a relay structure includes arranging, for each layer (k), a normalization layer for the layer (k) as coupled to and following a normalization layer for a preceding layer (k−1). Illustrated processing block 522 can generally be substituted for illustrated processing block 504. At illustrated processing block 524, the normalization layer for the layer (k) is coupled to the normalization layer for the preceding layer (k−1) via a hidden state signal and a cell state signal, each of the hidden state signal and a cell state signal generated by the normalization layer for the preceding layer (k−1). Illustrated processing block 524 can generally be substituted for at least a portion of illustrated processing block 522. At illustrated processing block 526, each normalization layer includes a meta-gating unit (MGU) structure. In some embodiments, the MGU structure includes a modified long-short term memory (LSTM) cell. At illustrated processing block 528, each normalization layer further includes a global average pooling (GAP) function, a standardization (STD) function and a linear transformation (LNT) function, wherein an output of the LNT function is coupled to an input of one of the plurality of convolution layers. The GAP function is operative on a feature map, and the LNT function is operative on an output of the STD function, where the LNT function is based on a hidden state signal generated by the MGU structure and a cell state signal generated by the MGU structure.

By employing the neural network technology as described herein with reference to FIGS. 1, 2A-2B, 3, 4A-4B, and 5A-5B, the MGU structure is integrated with meta-learning such that the hidden state hₖ and the cell state cₖ are set as the scale and shift parameters for calibrating the k-th layer video feature tensor, yₖ. By using the normalization layer relay structure and gating mechanism of the MGU, the calibration parameters for the k-th layer feature map can be conditioned on not only the current input feature map xₖ but also on the estimated calibration parameters cₖ₋₁ and hₖ₋₁ for the preceding (k−1) layer. Further, the neural network technology as described herein leverages observed video feature distributions to guide the learning dynamic of the current feature calibration layer. Intermediate video feature distributions are implicitly interdependent as a whole system, and with the shared MGU in CLN-CR, these potential conditions are extracted for learning of calibration parameters. Moreover, the disclosed technology explicitly exploits the holistic video feature correlation across layers and generates calibration parameters associated in a self-adaptive relay fashion for each individual video sample, both in training and inference. The parameters can be optimized simultaneously together with those of the main network in a backward pass since their computation flow is completely differentiable.

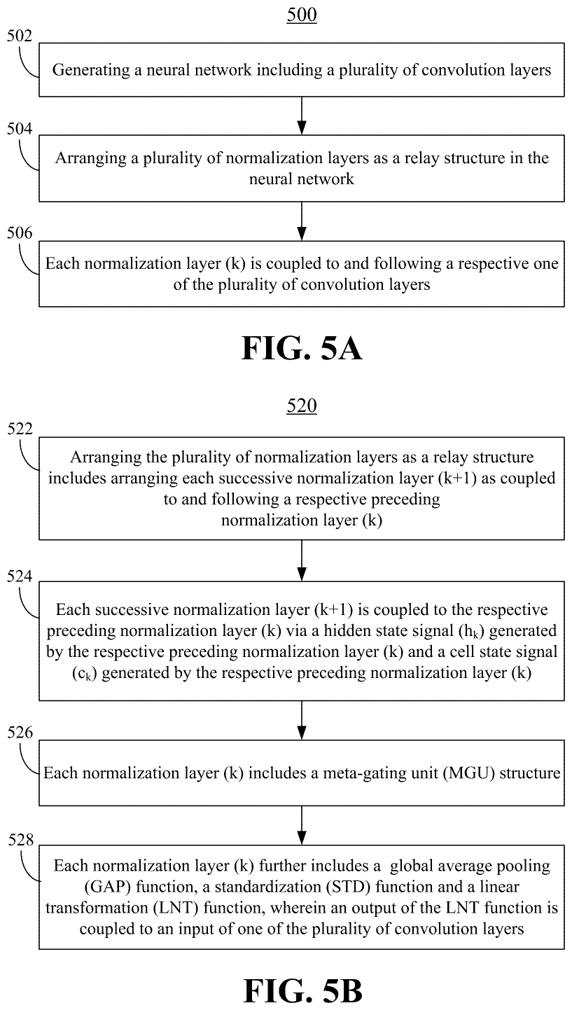

FIGS. 6A-6F provide illustrations of example input image sequences and corresponding activation maps in a system for image sequence analysis according to one or more embodiments, with reference to components and features described herein including but not limited to the figures and associated description. The input image sequences (shown in FIGS. 6A, 6C, and 6E as images converted to grayscale) were obtained from sample image sequences in the Kinetics-400 dataset, each input sequence shown including eight frames. The activation maps (shown in FIGS. 6B, 6D, and 6F as stacked on the respective input images from FIGS. 6A, 6C, and 6E and converted to grayscale) were generated by processing the input image sequences using an example of the neural network technology described herein. FIG. 6A provides an example of an input image sequence of guitar playing, as shown at label 602. FIG. 6B provides a set of activation maps as shown at label 604, each activation map shown stacked on and corresponding to one of the input images of FIG. 6A. FIG. 6C provides an example of an input image sequence of abseiling, as shown at label 612. FIG. 6D provides a set of activation maps as shown at label 614, each activation map shown stacked on and corresponding to one of the input images of FIG. 6C. FIG. 6E provides an example of an input image sequence of cow milking, as shown at label 622. FIG. 6F provides a set of activation maps as shown at label 624, each activation map shown stacked on and corresponding to one of the input images of FIG. 6E.

The bright areas of each activation map as shown in FIGS. 6B, 6D, and 6F show the areas identified by the neural network as areas of motion, with identified regions of motion during the sequence highlighted and concentrated as the sequence progresses. As demonstrated by each set of examples, the neural network technology described herein provides for consistent emphasis of holistic motion-related attentional regions within an image sequence or video clip with high confidence precision. This provides critical improvement of image sequence/video representation learning for downstream high-performance image sequence/video analysis tasks.

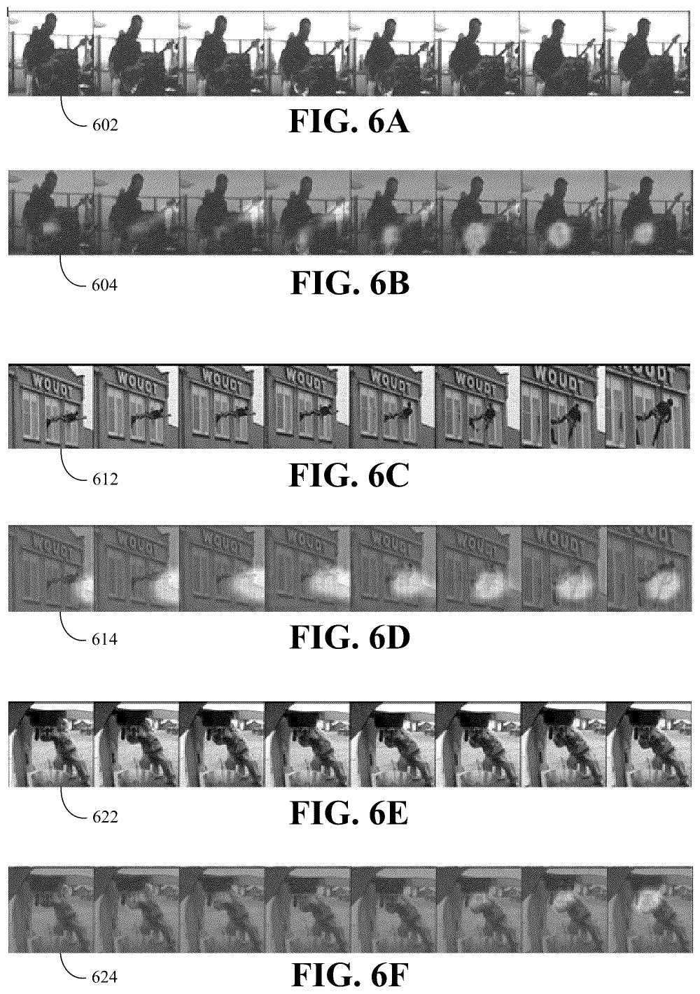

FIG. 7 shows a block diagram illustrating an example computing system 10 for image sequence/video analysis according to one or more embodiments, with reference to components and features described herein including but not limited to the figures and associated description. The system 10 can generally be part of an electronic device/platform having computing and/or communications functionality (e.g., server, cloud infrastructure controller, database controller, notebook computer, desktop computer, personal digital assistant/PDA, tablet computer, convertible tablet, smart phone, etc.), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof. In the illustrated example, the system 10 can include a host processor 12 (e.g., central processing unit/CPU) having an integrated memory controller (IMC) 14 that can be coupled to system memory 20. The host processor 12 can include any type of processing device, such as, e.g., microcontroller, microprocessor, RISC processor, ASIC, etc., along with associated processing modules or circuitry. The system memory 20 can include any non-transitory machine- or computer-readable storage medium such as RAM, ROM, PROM, EEPROM, firmware, flash memory, etc., configurable logic such as, for example, PLAs, FPGAs, CPLDs, fixed-functionality hardware logic using circuit technology such as, for example, ASIC, CMOS or TTL technology, or any combination thereof suitable for storing instructions 28.

The system 10 can also include an input/output (I/O) subsystem 16. The I/O subsystem 16 can communicate with for example, one or more input/output (I/O) devices 17, a network controller 24 (e.g., wired and/or wireless NIC), and storage 22. The storage 22 can be comprised of any appropriate non-transitory machine- or computer-readable memory type (e.g., flash memory, DRAM, SRAM (static random access memory), solid state drive (SSD), hard disk drive (HDD), optical disk, etc.). The storage 22 can include mass storage. In some embodiments, the host processor 12 and/or the I/O subsystem 16 can communicate with the storage 22 (all or portions thereof) via a network controller 24. In some embodiments, the system 10 can also include a graphics processor 26 (e.g., a graphics processing unit/GPU) and an AI accelerator 27. In an embodiment, the system 10 can also include a vision processing unit (VPU), not shown.

The host processor 12 and the I/O subsystem 16 can be implemented together on a semiconductor die as a system on chip (SoC) 11, shown encased in a solid line. The SoC 11 can therefore operate as a computing apparatus for image sequence/video analysis. In some embodiments, the SoC 11 can also include one or more of the system memory 20, the network controller 24, and/or the graphics processor 26 (shown encased in dotted lines). In some embodiments, the SoC 11 can also include other components of the system 10.

The host processor 12 and/or the I/O subsystem 16 can execute program instructions 28 retrieved from the system memory 20 and/or the storage 22 to perform one or more aspects of process 500 and/or process 520 as described herein with reference to FIGS. 5A-5B. The system 10 can implement one or more aspects of the system 100, the neural network 110, the neural network structure 200, the neural network structure 250, the normalization layer 300, the MGU structure 400, and/or the MGU structure 450 as described herein with reference to FIGS. 1, 2A-2B, 3, and 4A-4B. The system 10 is therefore considered to be performance-enhanced at least to the extent that the technology provides the ability to consistently identify motion-related attentional regions within an image sequence/video.

Computer program code to carry out the processes described above can be written in any combination of one or more programming languages, including an object-oriented programming language such as JAVA, JAVASCRIPT, PYTHON, SMALLTALK, C++ or the like and/or conventional procedural programming languages, such as the “C” programming language or similar programming languages, and implemented as program instructions 28. Additionally, program instructions 28 can include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, microprocessor, etc.).

I/O devices 17 can include one or more of input devices, such as a touch-screen, keyboard, mouse, cursor-control device, touch-screen, microphone, digital camera, video recorder, camcorder, biometric scanners and/or sensors; input devices can be used to enter information and interact with system 10 and/or with other devices. The I/O devices 17 can also include one or more of output devices, such as a display (e.g., touch screen, liquid crystal display/LCD, light emitting diode/LED display, plasma panels, etc.), speakers and/or other visual or audio output devices. The input and/or output devices can be used, e.g., to provide a user interface.

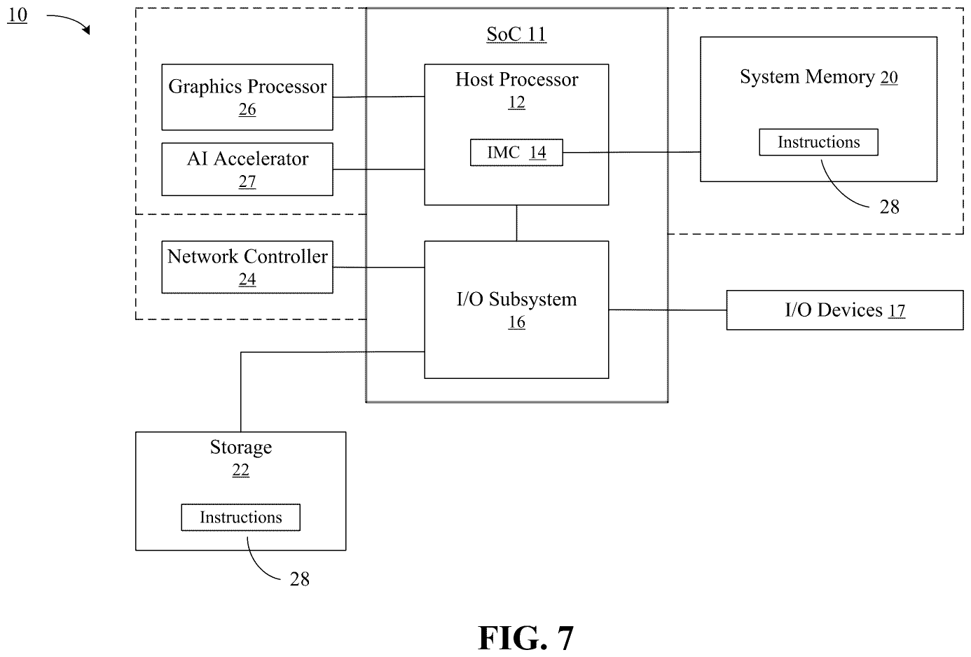

FIG. 8 shows a block diagram illustrating an example semiconductor apparatus 30 for image sequence/video analysis according to one or more embodiments, with reference to components and features described herein including but not limited to the figures and associated description. The semiconductor apparatus 30 can be implemented, e.g., as a chip, die, or other semiconductor package. The semiconductor apparatus 30 can include one or more substrates 32 comprised of, e.g., silicon, sapphire, gallium arsenide, etc. The semiconductor apparatus 30 can also include logic 34 comprised of, e.g., transistor array(s) and other integrated circuit (IC) components) coupled to the substrate(s) 32. The logic 34 can be implemented at least partly in configurable logic or fixed-functionality logic hardware. The logic 34 can implement the system on chip (SoC) 11 described above with reference to FIG. 7. The logic 34 can implement one or more aspects of the processes described above, including process 500 and/or process 520. The logic 34 can implement one or more aspects of the system 100, the neural network 110, the neural network structure 200, the neural network structure 250, the normalization layer 300, the MGU structure 400, and/or the MGU structure 450 as described herein with reference to FIGS. 1, 2A-2B, 3, and 4A-4B. The apparatus 30 is therefore considered to be performance-enhanced at least to the extent that the technology provides the ability to consistently identify motion-related attentional regions within an image sequence/video.

The semiconductor apparatus 30 can be constructed using any appropriate semiconductor manufacturing processes or techniques. For example, the logic 34 can include transistor channel regions that are positioned (e.g., embedded) within the substrate(s) 32. Thus, the interface between the logic 34 and the substrate(s) 32 may not be an abrupt junction. The logic 34 can also be considered to include an epitaxial layer that is grown on an initial wafer of the substrate(s) 34.

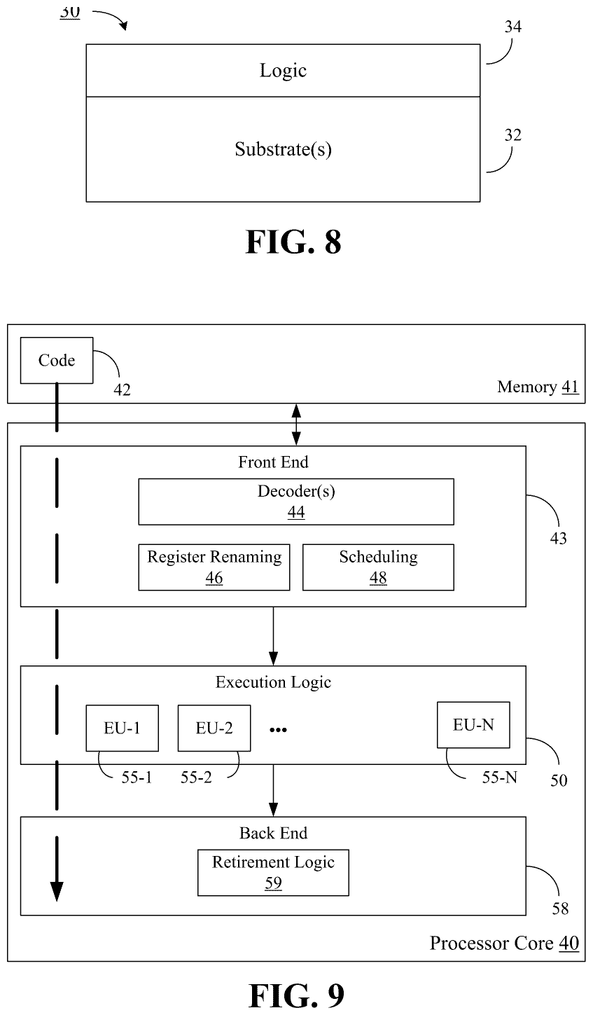

FIG. 9 is a block diagram illustrating an example processor core 40 according to one or more embodiments, with reference to components and features described herein including but not limited to the figures and associated description. The processor core 40 can be the core for any type of processor, such as a micro-processor, an embedded processor, a digital signal processor (DSP), a network processor, a graphics processing unit (GPU), or other device to execute code. Although only one processor core 40 is illustrated in FIG. 9, a processing element can alternatively include more than one of the processor core 40 illustrated in FIG. 9. The processor core 40 can be a single-threaded core or, for at least one embodiment, the processor core 40 can be multithreaded in that it can include more than one hardware thread context (or “logical processor”) per core.

FIG. 9 also illustrates a memory 41 coupled to the processor core 40. The memory 41 can be any of a wide variety of memories (including various layers of memory hierarchy) as are known or otherwise available to those of skill in the art. The memory 41 can include one or more code 42 instruction(s) to be executed by the processor core 40. The code 42 can implement one or more aspects of the processes 500 and/or 520 described above. The processor core 40 can implement one or more aspects of the system 100, the neural network 110, the neural network structure 200, the neural network structure 250, the normalization layer 300, the MGU structure 400, and/or the MGU structure 450 as described herein with reference to FIGS. 1, 2A-2B, 3, and 4A-4B. The processor core 40 can follow a program sequence of instructions indicated by the code 42. Each instruction can enter a front end portion 43 and be processed by one or more decoders 44. The decoder 44 can generate as its output a micro operation such as a fixed width micro operation in a predefined format, or can generate other instructions, microinstructions, or control signals which reflect the original code instruction. The illustrated front end portion 43 also includes register renaming logic 46 and scheduling logic 48, which generally allocate resources and queue the operation corresponding to the convert instruction for execution.

The processor core 40 is shown including execution logic 50 having a set of execution units 55-1 through 55-N. Some embodiments can include a number of execution units dedicated to specific functions or sets of functions. Other embodiments can include only one execution unit or one execution unit that can perform a particular function. The illustrated execution logic 50 performs the operations specified by code instructions.

After completion of execution of the operations specified by the code instructions, back end logic 58 retires the instructions of code 42. In one embodiment, the processor core 40 allows out of order execution but requires in order retirement of instructions. Retirement logic 59 can take a variety of forms as known to those of skill in the art (e.g., re-order buffers or the like). In this manner, the processor core 40 is transformed during execution of the code 42, at least in terms of the output generated by the decoder, the hardware registers and tables utilized by the register renaming logic 46, and any registers (not shown) modified by the execution logic 50.

Although not illustrated in FIG. 9, a processing element can include other elements on chip with the processor core 40. For example, a processing element can include memory control logic along with the processor core 40. The processing element can include I/O control logic and/or can include I/O control logic integrated with memory control logic. The processing element can also include one or more caches.

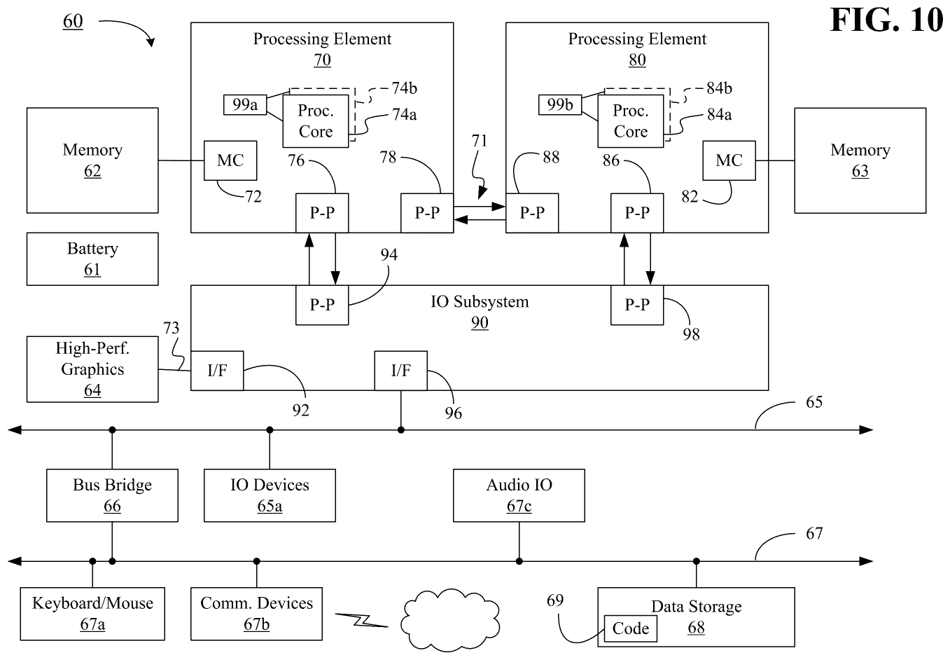

FIG. 10 is a block diagram illustrating an example of a multi-processor based computing system 60 according to one or more embodiments, with reference to components and features described herein including but not limited to the figures and associated description. The multiprocessor system 60 includes a first processing element 70 and a second processing element 80. While two processing elements 70 and 80 are shown, it is to be understood that an embodiment of the system 60 can also include only one such processing element.

The system 60 is illustrated as a point-to-point interconnect system, wherein the first processing element 70 and the second processing element 80 are coupled via a point-to-point interconnect 71. It should be understood that any or all of the interconnects illustrated in FIG. 10 can be implemented as a multi-drop bus rather than point-to-point interconnect.

As shown in FIG. 10, each of the processing elements 70 and 80 can be multicore processors, including first and second processor cores (i.e., processor cores 74a and 74b and processor cores 84a and 84b). Such cores 74a, 74b, 84a, 84b can be configured to execute instruction code in a manner similar to that discussed above in connection with FIG. 9.

Each processing element 70, 80 can include at least one shared cache 99a, 99b. The shared cache 99a, 99b can store data (e.g., instructions) that are utilized by one or more components of the processor, such as the cores 74a, 74b and 84a, 84b, respectively. For example, the shared cache 99a, 99b can locally cache data stored in a memory 62, 63 for faster access by components of the processor. In one or more embodiments, the shared cache 99a, 99b can include one or more mid-level caches, such as level 2 (L2), level 3 (L3), level 4 (L4), or other levels of cache, a last level cache (LLC), and/or combinations thereof.

While shown with only two processing elements 70, 80, it is to be understood that the scope of the embodiments is not so limited. In other embodiments, one or more additional processing elements can be present in a given processor. Alternatively, one or more of the processing elements 70, 80 can be an element other than a processor, such as an accelerator or a field programmable gate array. For example, additional processing element(s) can include additional processors(s) that are the same as a first processor 70, additional processor(s) that are heterogeneous or asymmetric to processor a first processor 70, accelerators (such as, e.g., graphics accelerators or digital signal processing (DSP) units), field programmable gate arrays, or any other processing element. There can be a variety of differences between the processing elements 70, 80 in terms of a spectrum of metrics of merit including architectural, micro architectural, thermal, power consumption characteristics, and the like. These differences can effectively manifest themselves as asymmetry and heterogeneity amongst the processing elements 70, 80. For at least one embodiment, the various processing elements 70, 80 can reside in the same die package.

The first processing element 70 can further include memory controller logic (MC) 72 and point-to-point (P-P) interfaces 76 and 78. Similarly, the second processing element 80 can include a MC 82 and P-P interfaces 86 and 88. As shown in FIG. 10, MC's 72 and 82 couple the processors to respective memories, namely a memory 62 and a memory 63, which can be portions of main memory locally attached to the respective processors. While the MC 72 and 82 is illustrated as integrated into the processing elements 70, 80, for alternative embodiments the MC logic can be discrete logic outside the processing elements 70, 80 rather than integrated therein.

The first processing element 70 and the second processing element 80 can be coupled to an I/O subsystem 90 via P-P interconnects 76 and 86, respectively. As shown in FIG. 10, the I/O subsystem 90 includes P-P interfaces 94 and 98. Furthermore, the I/O subsystem 90 includes an interface 92 to couple I/O subsystem 90 with a high performance graphics engine 64. In one embodiment, a bus 73 can be used to couple the graphics engine 64 to the I/O subsystem 90. Alternately, a point-to-point interconnect can couple these components.

In turn, the I/O subsystem 90 can be coupled to a first bus 65 via an interface 96. In one embodiment, the first bus 65 can be a Peripheral Component Interconnect (PCI) bus, or a bus such as a PCI Express bus or another third generation I/O interconnect bus, although the scope of the embodiments are not so limited.

As shown in FIG. 10, various I/O devices 65a (e.g., biometric scanners, speakers, cameras, and/or sensors) can be coupled to the first bus 65, along with a bus bridge 66 which can couple the first bus 65 to a second bus 67. In one embodiment, the second bus 67 can be a low pin count (LPC) bus. Various devices can be coupled to the second bus 67 including, for example, a keyboard/mouse 67a, communication device(s) 67b, and a data storage unit 68 such as a disk drive or other mass storage device which can include code 69, in one embodiment. The illustrated code 69 can implement one or more aspects of the processes described above, including process 500 and/or process 520. The illustrated code 69 can be similar to the code 42 (FIG. 9), already discussed. Further, an audio I/O 67c can be coupled to second bus 67 and a battery 61 can supply power to the computing system 60. The system 60 can implement one or more aspects of the system 100, the neural network 110, the neural network structure 200, the neural network structure 250, the normalization layer 300, the MGU structure 400, and/or the MGU structure 450 as described herein with reference to FIGS. 1, 2A-2B, 3, and 4A-4B.

Note that other embodiments are contemplated. For example, instead of the point-to-point architecture of FIG. 10, a system can implement a multi-drop bus or another such communication topology. Also, the elements of FIG. 10 can alternatively be partitioned using more or fewer integrated chips than shown in FIG. 10.

Embodiments of each of the above systems, devices, components and/or methods, including the system 10, the semiconductor apparatus 30, the processor core 40, the system 60, the system 100, the neural network 110, the neural network structure 200, the neural network structure 250, the normalization layer 300, the MGU structure 400, the MGU structure 450, process 500, and/or process 520, and/or any other system components, can be implemented in hardware, software, or any suitable combination thereof. For example, hardware implementations can include configurable logic such as, for example, PLAs, FPGAs, CPLDs, or fixed-functionality logic hardware using circuit technology such as, for example, ASIC, CMOS or TTL technology, or any combination thereof.

Alternatively, or additionally, all or portions of the foregoing systems and/or components and/or methods can be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages.

### ADDITIONAL NOTES AND EXAMPLES

Example 1 includes a computing system, comprising a processor, and a memory coupled to the processor, the memory storing a neural network, the neural network comprising a plurality of convolution layers, and a plurality of normalization layers arranged as a relay structure, wherein each normalization layer is coupled to and following a respective one of the plurality of convolution layers.

Example 2 includes the computing system of Example 1, wherein the plurality of normalization layers arranged as a relay structure comprises, for each layer (k), a normalization layer for the layer (k) coupled to and following a normalization layer for a preceding layer (k−1).

Example 3 includes the computing system of Example 2, wherein the normalization layer for the layer (k) is coupled to the normalization layer for the preceding layer (k−1) via a hidden state signal and a cell state signal, each of the hidden state signal and a cell state signal generated by the normalization layer for the preceding layer (k−1).

Example 4 includes the computing system of Example 3, wherein each normalization layer comprises a meta-gating unit (MGU) structure.

Example 5 includes the computing system of Example 4, wherein the MGU structure comprises a modified long-short term memory (LSTM) cell.

Example 6 includes the computing system of any one of Examples 1-5, wherein each normalization layer further comprises a global average pooling (GAP) function operative on a feature map, a standardization (STD) function operative on the feature map, and a linear transformation (LNT) function operative on an output of the STD function, the LNT function based on a hidden state signal to be generated by the MGU structure and on a cell state signal to be generated by the MGU structure, wherein an output of the LNT function is coupled to an input of one of the plurality of convolution layers.

Example 7 includes a semiconductor apparatus comprising one or more substrates, and logic coupled to the one or more substrates, wherein the logic is implemented at least partly in one or more of configurable logic or fixed-functionality hardware logic, the logic coupled to the one or more substrates comprising a neural network, the neural network comprising a plurality of convolution layers, and a plurality of normalization layers arranged as a relay structure, wherein each normalization layer is coupled to and following a respective one of the plurality of convolution layers.

Example 8 includes the apparatus of Example 7, wherein the plurality of normalization layers arranged as a relay structure comprises, for each layer (k), a normalization layer for the layer (k) coupled to and following a normalization layer for a preceding layer (k−1).

Example 9 includes the apparatus of Example 8, wherein the normalization layer for the layer (k) is coupled to the normalization layer for the preceding layer (k−1) via a hidden state signal and a cell state signal, each of the hidden state signal and a cell state signal generated by the normalization layer for the preceding layer (k−1).

Example 10 includes the apparatus of Example 9, wherein each normalization layer comprises a meta-gating unit (MGU) structure.

Example 11 includes the apparatus of Example 10, wherein the MGU structure comprises a modified long-short term memory (LSTM) cell.

Example 12 includes the apparatus of any one of Examples 7-11, wherein each normalization layer further comprises a global average pooling (GAP) function operative on a feature map, a standardization (STD) function operative on the feature map, and a linear transformation (LNT) function operative on an output of the STD function, the LNT function based on a hidden state signal to be generated by the MGU structure and on a cell state signal to be generated by the MGU structure, wherein an output of the LNT function is coupled to an input of one of the plurality of convolution layers.

Example 13 includes the apparatus of Example 7, wherein the logic coupled to the one or more substrates includes transistor channel regions that are positioned within the one or more substrates.

Example 14 includes at least one non-transitory computer readable storage medium comprising a set of instructions which, when executed by a computing system, cause the computing system to generate a neural network comprising a plurality of convolution layers, and arrange a plurality of normalization layers as a relay structure in the neural network, wherein each normalization layer is coupled to and following a respective one of the plurality of convolution layers.

Example 15 includes the at least one non-transitory computer readable storage medium of Example 14, wherein to arrange the plurality of normalization layers as a relay structure comprises to arrange, for each layer (k), a normalization layer for the layer (k) as coupled to and following a normalization layer for a preceding layer (k−1).

Example 16 includes the at least one non-transitory computer readable storage medium of Example 15, wherein the normalization layer for the layer (k) is to be coupled to the normalization layer for the preceding layer (k−1) via a hidden state signal and a cell state signal, each of the hidden state signal and a cell state signal to be generated by the normalization layer for the preceding layer (k−1).

Example 17 includes the at least one non-transitory computer readable storage medium of Example 16, wherein each normalization layer comprises a meta-gating unit (MGU) structure.

Example 18 includes the at least one non-transitory computer readable storage medium of Example 17, wherein the MGU structure comprises a modified long-short term memory (LSTM) cell.

Example 19 includes the at least one non-transitory computer readable storage medium of any one of Examples 14-18, wherein each normalization layer further comprises a global average pooling (GAP) function operative on a feature map, a standardization (STD) function operative on the feature map, and a linear transformation (LNT) function operative on an output of the STD function, the LNT function based on a hidden state signal to be generated by the MGU structure and on a cell state signal to be generated by the MGU structure, wherein an output of the LNT function is to be coupled to an input of one of the plurality of convolution layers.

Example 20 includes a method comprising generating a neural network comprising a plurality of convolution layers, and arranging a plurality of normalization layers as a relay structure in the neural network, wherein each normalization layer is coupled to and following a respective one of the plurality of convolution layers.

Example 21 includes the method of Example 20, wherein arranging the plurality of normalization layers as a relay structure comprises arranging, for each layer (k), a normalization layer for the layer (k) as coupled to and following a normalization layer for a preceding layer (k−1).

Example 22 includes the method of Example 21, wherein the normalization layer for the layer (k) is coupled to the normalization layer for the preceding layer (k−1) via a hidden state signal and a cell state signal, each of the hidden state signal and a cell state signal generated by the normalization layer for the preceding layer (k−1).

Example 23 includes the method of Example 22, wherein each normalization layer comprises a meta-gating unit (MGU) structure.

Example 24 includes the method of Example 23, wherein the MGU structure comprises a modified long-short term memory (LSTM) cell.

Example 25 includes the method of any one of Examples 20-24, wherein each normalization layer further comprises a global average pooling (GAP) function operative on a feature map, a standardization (STD) function operative on the feature map, and a linear transformation (LNT) function operative on an output of the STD function, the LNT function based on a hidden state signal generated by the MGU structure and on a cell state signal generated by the MGU structure, wherein an output of the LNT function is coupled to an input of one of the plurality of convolution layers.

Example 26 includes an apparatus comprising means for performing the method of any one of Examples 20-24.

Thus, technology described herein improves the performance of computing systems used in image sequence/video analysis tasks, both as to significant speed-up in training and in improvement in accuracy. The technology described herein may be applicable in any number of computing scenarios, including, e.g., deployment of deep video models on edge/cloud devices and in high-performance distributed/parallel computing systems.

Embodiments are applicable for use with all types of semiconductor integrated circuit (“IC”) chips. Examples of these IC chips include but are not limited to processors, controllers, chipset components, PLAs, memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-25. (canceled)

26. A computing system for image sequence or video analysis, comprising:
a processor; and
a memory coupled to the processor, the memory storing a neural network, the neural network comprising:
a plurality of convolution layers; and
a plurality of normalization layers arranged as a relay structure, wherein each normalization layer is coupled to and following a respective one of the plurality of convolution layers.

27. The computing system of claim 26, wherein the plurality of normalization layers arranged as a relay structure comprises, for each layer (k), a normalization layer for the layer (k) coupled to and following a normalization layer for a preceding layer (k−1).

28. The computing system of claim 27, wherein the normalization layer for the layer (k) is coupled to the normalization layer for the preceding layer (k−1) via a hidden state signal and a cell state signal, each of the hidden state signal and a cell state signal generated by the normalization layer for the preceding layer (k−1).

29. The computing system of claim 28, wherein each normalization layer comprises a meta-gating unit (MGU) structure.

30. The computing system of claim 29, wherein the MGU structure comprises a modified long-short term memory (LSTM) cell.

31. The computing system of claim 30, wherein each normalization layer further comprises:
a global average pooling (GAP) function operative on a feature map;
a standardization (STD) function operative on the feature map; and
a linear transformation (LNT) function operative on an output of the STD function, the LNT function based on a hidden state signal to be generated by the MGU structure and on a cell state signal to be generated by the MGU structure,
wherein an output of the LNT function is coupled to an input of one of the plurality of convolution layers.

32. A semiconductor apparatus for image sequence or video analysis comprising:
one or more substrates; and
logic coupled to the one or more substrates, wherein the logic is implemented at least partly in one or more of configurable logic or fixed-functionality hardware logic, the logic coupled to the one or more substrates comprising a neural network, the neural network comprising:
a plurality of convolution layers; and
a plurality of normalization layers arranged as a relay structure, wherein each normalization layer is coupled to and following a respective one of the plurality of convolution layers.

33. The apparatus of claim 32, wherein the plurality of normalization layers arranged as a relay structure comprises, for each layer (k), a normalization layer for the layer (k) coupled to and following a normalization layer for a preceding layer (k−1).

34. The apparatus of claim 33, wherein the normalization layer for the layer (k) is coupled to the normalization layer for the preceding layer (k−1) via a hidden state signal and a cell state signal, each of the hidden state signal and a cell state signal generated by the normalization layer for the preceding layer (k−1).

35. The apparatus of claim 34, wherein each normalization layer comprises a meta-gating unit (MGU) structure.

36. The apparatus of claim 35, wherein the MGU structure comprises a modified long-short term memory (LSTM) cell.

37. The apparatus of claim 36, wherein each normalization layer further comprises:
a global average pooling (GAP) function operative on a feature map;
a standardization (STD) function operative on the feature map; and
a linear transformation (LNT) function operative on an output of the STD function, the LNT function based on a hidden state signal to be generated by the MGU structure and on a cell state signal to be generated by the MGU structure,
wherein an output of the LNT function is coupled to an input of one of the plurality of convolution layers.

38. The apparatus of claim 32, wherein the logic coupled to the one or more substrates includes transistor channel regions that are positioned within the one or more substrates.

39. At least one non-transitory computer readable storage medium comprising a set of instructions for image sequence or video analysis which, when executed by a computing system, cause the computing system to:
generate a neural network comprising a plurality of convolution layers; and
arrange a plurality of normalization layers as a relay structure in the neural network, wherein each normalization layer is coupled to and following a respective one of the plurality of convolution layers.

40. The at least one non-transitory computer readable storage medium of claim 39, wherein to arrange the plurality of normalization layers as a relay structure comprises to arrange, for each layer (k), a normalization layer for the layer (k) as coupled to and following a normalization layer for a preceding layer (k−1).

41. The at least one non-transitory computer readable storage medium of claim 40, wherein the normalization layer for the layer (k) is to be coupled to the normalization layer for the preceding layer (k−1) via a hidden state signal and a cell state signal, each of the hidden state signal and a cell state signal to be generated by the normalization layer for the preceding layer (k−1).

42. The at least one non-transitory computer readable storage medium of claim 41, wherein each normalization layer comprises a meta-gating unit (MGU) structure.

43. The at least one non-transitory computer readable storage medium of claim 42, wherein the MGU structure comprises a modified long-short term memory (LSTM) cell.

44. The at least one non-transitory computer readable storage medium of claim 43, wherein each normalization layer further comprises:
a global average pooling (GAP) function operative on a feature map;
a standardization (STD) function operative on the feature map; and
a linear transformation (LNT) function operative on an output of the STD function, the LNT function based on a hidden state signal to be generated by the MGU structure and on a cell state signal to be generated by the MGU structure,
wherein an output of the LNT function is to be coupled to an input of one of the plurality of convolution layers.

45. A method for image sequence or video analysis, comprising:
generating a neural network comprising a plurality of convolution layers; and
arranging a plurality of normalization layers as a relay structure in the neural network, wherein each normalization layer is coupled to and following a respective one of the plurality of convolution layers.

46. The method of claim 45, wherein arranging the plurality of normalization layers as a relay structure comprises arranging, for each layer (k), a normalization layer for the layer (k) as coupled to and following a normalization layer for a preceding layer (k−1).

47. The method of claim 46, wherein the normalization layer for the layer (k) is coupled to the normalization layer for the preceding layer (k−1) via a hidden state signal and a cell state signal, each of the hidden state signal and a cell state signal generated by the normalization layer for the preceding layer (k−1).

48. The method of claim 47, wherein each normalization layer comprises a meta-gating unit (MGU) structure.

49. The method of claim 48, wherein the MGU structure comprises a modified long-short term memory (LSTM) cell.

50. The method of claim 49, wherein each normalization layer further comprises:
a global average pooling (GAP) function operative on a feature map;
a standardization (STD) function operative on the feature map; and
a linear transformation (LNT) function operative on an output of the STD function, the LNT function based on a hidden state signal generated by the MGU structure and on a cell state signal generated by the MGU structure,
wherein an output of the LNT function is coupled to an input of one of the plurality of convolution layers.
